(19) United States
(12) Patent Application Publication
(10) Pub. No.: US 2002/0125017 A1
(43) Pub. Date: Sep. 12, 2002

(54) Plow blade with liquid chemical injection apparatus

(76) Inventors: Jerome Robillard, Pella, IA (US); Keith Hoelting, Allerton, IA (US)

Correspondence Address: HENDERSON & STURM LLP, 1213 MIDLAND BUILDING, 206 SIXTH AVENUE, DES MOINES, IA, 50309-4076, US

(21) Appl. No.: 09/801,303

(22) Filed: Mar. 7, 2001

(51) Int. Cl. A01B 35/00

(52) U.S. Cl. 172/40

(57) ABSTRACT

A vibratory or static plow blade assembly including a blade for opening a slit in the ground, a chute assembly operably attached to the blade for being pulled through the slit in the ground and wherein the chute assembly includes a top opening for allowing an elongated product such as a utility line to be installed in the ground by being inserted into the chute assembly. A product exit point in the chute assembly is disposed below the top opening and internal guides are provided for directing the product to the exit point. At least one nozzle is provided adjacent the exit point for transferring a pressurized material into a desired contact with the product being installed in the ground. Conduits for transferring the pressurized material from above the ground to the nozzles are disposed within the chute assembly. A product exit point is disposed for positioning the utility line or other product and the nozzles relative to the blade in a manner to ensure proper clearance between the ground and the product, proper depth of the product, and proper space for the pressurized material. In a preferred embodiment nozzles are radially outward from the utility line and adjacent to the exit point.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to a plow blade assembly of a type used to install utility lines and more particularly to such a plow blade assembly which injects a liquid chemical around the discharge exit point of the utility line as the utility line is being laid into the ground for protecting the utility line.

2. Description of the Related Art

Current utilities are installed in a variety of methods including open trench installation, vibratory plow installation and horizontal directional drilling, etc. These utility lines are installed at a variety of depths, as required by soil conditions and types of the utilities being installed. Deep installations avoid some potential hazards resulting from movement of the ground or elements in the ground, potentially caused by frost or surface disruptions. Shallower installations are sometimes necessary due to unfavorable conditions encountered at deeper depths. Additionally, it is typically less costly to install utility lines at a shallower depth. However, at shallower depths, the likelihood of damage to the utility lines increase.

### BRIEF SUMMARY OF THE INVENTION

There exists a need to install utility lines at relatively shallow depths, with a method of protecting the utility lines from damage. Experimentation is being conducted to identify possible chemicals or fluids that potentially expand upon being injected into air, in contact with a product or utility line, such chemical having physical properties capable of protecting the utility lines. If this type of material is developed, an apparatus will be needed to enable to process.

The present invention discloses an apparatus capable of transferring a pressurized material from above ground to nozzles positioned to inject the material from a controlled contact with a product being installed into the ground and to control the space within the ground in which the injected material will be allowed to flow, and to control the location of the product within such space.

A vibratory or static plow assembly of the present invention includes a vibrating or static blade that serves to open a slit in the ground. A chute assembly attaches to the blade and is pulled through the slit in the ground. The chute assembly includes a top opening to allow a utility line to be installed in the ground to be inserted into the chute and internal guides direct the utility line to a product exit point. Nozzles disposed around the exit point are provided to transfer pressurized material, such as a foam material, into a desired contact with the utility line being installed in the ground. Conduits are attached to each nozzle to transfer pressurized material from above the ground to the nozzles. The product exit point is designed to position the product and the nozzles relative to the blade in a manner to ensure proper clearance between the ground and the product, proper depth of the product, and proper space for the pressurized material.

The present invention is capable of transferring a pressurized material from above the ground to nozzles positioned adjacent to the utility line as it is being laid in the ground to inject the material into controlled contact with the utility line being installed in the ground and to control the space within the ground in which the injected material will be allowed to flow, thereby controlling the location of the product within such space.

An object of the present invention is to provide a plow blade for installing utility lines having an injection apparatus for applying a protective coating on such utility lines as they are being laid into the ground.

Another object of the present invention is to avoid some potential hazards resulting from movement of a utility line potentially caused by frost or surface disruptions.

A further object of the present invention is to provide a protective coating on utility lines so that they can be installed shallower than they would otherwise need to be installed.

Other objects, advantages and novel features of the present invention will become apparent from the following detailed description of the invention when considered in conjunction with the accompanying drawings.

### BRIEF DESCRIPTION OF THE SEVERAL VIEWS OF THE DRAWINGS

FIG. 1 is a side elevational view of a vibratory or a static plow blade assembly having a blade for opening a slit in the ground and a chute assembly for installing a utility line and having hoses for chemically coating the utility line as it is laid into the ground; and

FIG. 2 is a view taken along line 2-2 of FIG. 1 showing nozzles for injecting a fluid chemical around a utility line.

### DETAILED DESCRIPTION OF THE INVENTION

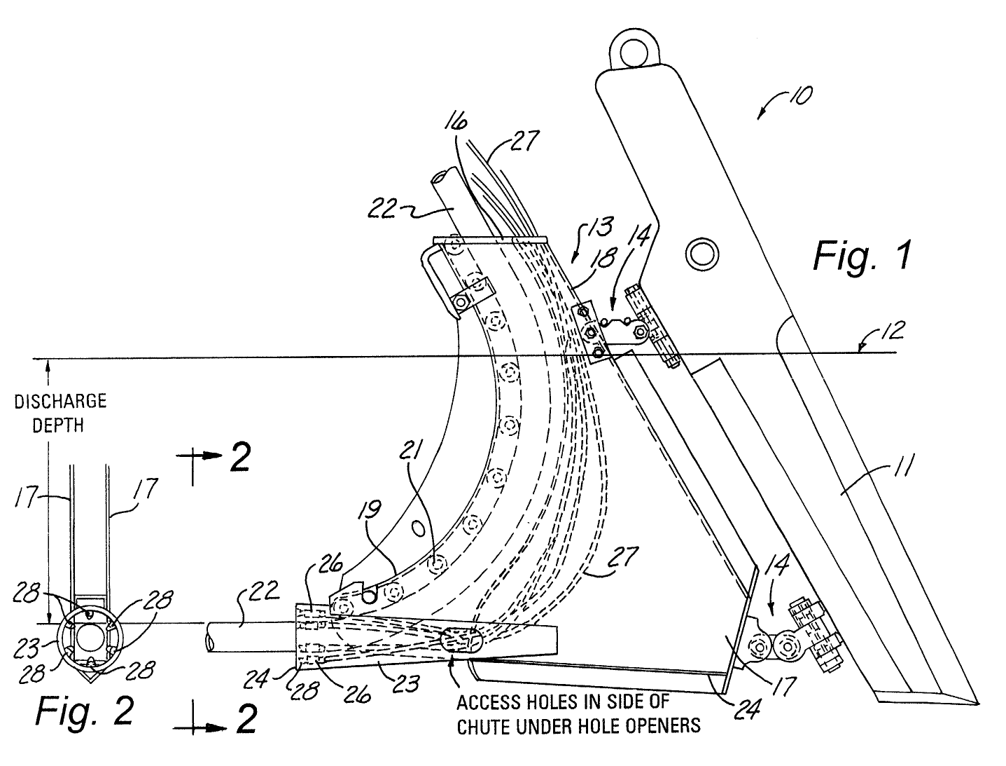

Referring now to the drawings, wherein like reference numerals designate identical or corresponding parts throughout the several views, FIG. 1 shows a vibratory or a static plow blade assembly (10) constructed in accordance with the present invention and having a plow blade (11) for opening a slit in the ground, the ground line indicated by numeral (12). A chute assembly (13) is connected to the plow blade (11) by linkage connectors (14) which are of conventional design. It will be understood that the blade (11) can be vibrated to make it pass through the ground more easily, or it can merely be static and pushed or pulled through the ground.

The chute assembly (13) has a top opening (16) and sides (17). There is a back panel (18) and a front panel (19). The side panels (17) can be removable or, alternatively, the front panel (19) can be removable to gain access to the inside of the chute assembly (13). Rollers (21) are provided inside of the chute assembly (13) between side walls (17) to cut down on the friction of utility line (22), which could be a gas line, cable television line, telephone line or any other linear flexible product desired to be laid into the ground. Typically, the utility line (22) is disposed on a roll to which the plow blade assembly (10) is attached and the utility line (21) becomes unrolled into the bottom of the slit in the ground made by plow blade (11) as it moves to the right as shown in FIG. 1.

A hole opener (23) is attached to the sides (17) of the chute assembly (13) and can also be attached to the bottom wall (24) if desired. The hole opening (23) has the utility line (22) passing through and into the top area thereof and out the bottom circular portion (24). This will spread the slot in the ground at that level to some extent around utility line (22). Nozzles (26) are positioned around the inner periphery of the hole opener (23) adjacent to the end (24) of the hole opener but could be positioned forwardly or rearwardly from the place shown in FIG. 1. Hoses (27) extend through the top opening (16) of the chute assembly (13). The hoses (27) are disposed between the side walls (17) of the chute assembly (13) and are in fluid communication with the nozzles (26). The chute assembly (16) is built with an extra cavity inside the hole opener (23). This extra cavity allows a fluid chemical to be inserted through the nozzles (26) without getting in the way of the utility line (22) and further protects the hoses (27) from adverse conditions once it is in the ground. There are access holes in the side of the chute at a discharge depth. This allows the hoses (27) to extend out of the cavity within opener (23).

Tapered hollow hole openers (23) are affixed to both sides of the chute at the discharge depth. This opens a hole around the utility line or other product as it comes out of the chute assembly (13) at the discharge depth. The hole openers (23) are placed over the access holes in the sides of the chute to protect the fluid chemical lines or hoses (27). There are threaded tubes (26) placed around the inside diameter of the hole opener (23). The fluid chemical lines are threaded back in to the backside of the tubes (26). There are directional spray nozzles (28) on the other side of the threaded tubes which direct the fluid chemical evenly around the utility line (22). It is not absolute critical that the nozzles (28) be evenly spaced around the utility line (22) or that there is even more than one nozzle. The drawings however show a preferred embodiment of the invention.

Accordingly it will be appreciated that the preferred embodiment disclosed herein does indeed accomplish the aforementioned objects. Obviously many modifications and variations of the present invention are possible in light of the above teachings. It is therefore to be understood that, within the scope of the appended claims, the invention may be practiced otherwise than as specifically described.

We claim:

1. A vibratory or a static plow blade assembly comprising a blade for opening a slit in the ground, a chute assembly operatively attached to the blade for being pulled through the silt in the ground, said chute assembly including:
a top opening for allowing an elongated product to be installed in the ground to be inserted into the chute assembly;
a product exit point below said top opening;
internal guides for directing the product to the exit point;
nozzles for transferring a pressurized material into a desired contact with the product being installed in the ground;
conduits for transferring the pressurized material from above ground to the nozzles; and
whereby the product exit point is disposed for positioning the product and the nozzles relative to the blade in a manner to ensure proper clearance between the ground and the product, proper depth of the product, and proper space for the pressurized material, said nozzles being radially outward from the product and adjacent to said exit point.
